(19) United States
(12) Patent Application Publication
(10) Pub. No.: US 2020/0391811 A1
(43) Pub. Date: Dec. 17, 2020

(54) DEPLOYABLE PANELS FOR DRAG REDUCTION AND STABILITY

(71) Applicant: GM GLOBAL TECHNOLOGY OPERATIONS LLC, DETROIT, MI (US)

(72) Inventors: Taeyoung Han, Bloomfield Hills, MI (US); Wonhee M. Kim, Royal Oak, MI (US); Chih-hung Yen, Bloomfield Hills, MI (US); Bahram Khalighi, Birmingham, MI (US); Paul E. Krajewski, Troy, MI (US)

(21) Appl. No.: 16/443,029

(22) Filed: Jun. 17, 2019

(51) Int. Cl. B62D 35/00; F16H 25/20

(52) U.S. Cl. CPC B62D 35/008; F16H 2025/2081; F16H 2025/2059; F16H 25/20

(57) ABSTRACT

A deployable panel for a vehicle, the deployable panel including: a telescopically adjustable body, where, when in a retracted state, the body is configured to be enclosed within at least a portion of the vehicle, and where, when in an extended state, the body is configured to reduce aerodynamic drag generated during movement of the vehicle or increase aerodynamic stability against external forces impacting at least one side of the vehicle; and a linear actuator installed within the body, the linear actuator configured to telescopically adjust the body from the retracted state to the extended state or somewhere therebetween.

### INTRODUCTION

Panels mounted to the sides of a vehicle's rear end have been found to be beneficial by improving a vehicle's fuel economy as well as lessening aerodynamic drag, which will reduce the vehicle's emissions and carbon footprint. These side-rear panels can also improve the vehicle's aerodynamic stability by controlling the side forces impacting the vehicle while moving through unsteady winds. However, such side-rear panels are not thought of as being desirable by vehicle owners because they look awkward and are not otherwise aesthetically pleasing. It is thus desirable to provide a vehicle with deployable side-rear panels, which can provide all the benefits discussed above while the vehicle is in movement but can also be hidden from the sight of the vehicle owner and onlookers when the vehicle is stopped. It is also desirable to provide these deployable panels with an actuation component that reinforces the panel's stability. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a deployable panel for a vehicle, the deployable panel including: a telescopically adjustable body, where, when in a retracted state, the body is configured to be enclosed within at least a portion of the vehicle, and where, when in an extended state, the body is configured to reduce aerodynamic drag generated during movement of the vehicle or increase aerodynamic stability against external forces impacting at least one side of the vehicle; and a linear actuator installed within the body, the linear actuator configured to telescopically adjust the body from the retracted state to the extended state or somewhere therebetween. Other embodiments of this aspect include corresponding computer systems, apparatus, and computer programs recorded on one or more computer storage devices, each configured to perform the actions of the methods.

Implementations may include one or more of the following features. The deployable panel where the linear actuator includes: an actuation gear; first and second internal rods being in operative contact with the actuation gear; first and second intermediate rods being operatively connected to the first and second internal rods; first and second end tubes being operatively connected to the first and second intermediate rods; where, when the actuation gear is rotated in a first direction, the first and second internal rods will rotate respectively such that the first and second intermediate rods will both rotate respectively and telescopically extend away from the first and second internal rods and the first and second end tubes will telescopically extend away from the first and second intermediate rods; and where, when the actuation gear is rotated in a second direction, the first and second internal rods will rotate respectively such that the first and second intermediate rods will both rotate respectively and telescopically retract towards the first and second internal rods and the first and second end tubes will telescopically retract towards the first and second intermediate rods. The deployable panel where: the first and second internal rods each having a threaded exterior; the first and second intermediate rods each having a threaded exterior and a threaded bore hole; and the first and second end tubes each including a threaded bore hole. The deployable panel where the body includes a plurality of plates operatively connected to each other so as to allow telescopic adjustment of the deployable panel, the plates configured to house at least a portion of the linear actuator. The deployable panel where: the first and second internal rods are mounted to a first plate via a first flange; the first and second intermediate plates are mounted to a second plate via a second flange; and the first and second end tubes are mounted directly to a third plate. The deployable panel being installed at a side of a rear end of the vehicle. The deployable panel being installed on a rear bumper of the vehicle. Implementations of the described techniques may include hardware, a method or process, or computer software on a computer-accessible medium.

One general aspect includes a vehicle including: a deployable panel located at each side of a rear end of the vehicle, each deployable panel including: a telescopically adjustable body, where, when in a retracted state, the body is configured to be enclosed within at least a portion of the vehicle, and where, when in an extended state, the body is configured to reduce aerodynamic drag generated during movement of the vehicle; and a linear actuator installed within the body, the linear actuator configured to telescopically adjust the body from the retracted state to the extended state or somewhere therebetween. Other embodiments of this aspect include corresponding computer systems, apparatus, and computer programs recorded on one or more computer storage devices, each configured to perform the actions of the methods.

Implementations may include one or more of the following features. The vehicle where the linear actuator includes: an actuation gear; first and second internal rods being in operative contact with the actuation gear; first and second intermediate rods being operatively connected to the first and second internal rods; first and second end tubes being operatively connected to the first and second intermediate rods; where, when the actuation gear is rotated in a first direction, the first and second internal rods will rotate respectively such that the first and second intermediate rods will both rotate respectively and telescopically extend away from the first and second internal rods and the first and second end tubes will telescopically extend away from the first and second intermediate rods; and where, when the actuation gear is rotated in a second direction, the first and second internal rods will rotate respectively such that the first and second intermediate rods will both rotate respectively and telescopically retract towards the first and second internal rods and the first and second end tubes will telescopically retract towards the first and second intermediate rods. The vehicle where: the first and second internal rods each having a threaded exterior; the first and second intermediate rods each having a threaded exterior and a threaded bore hole; and the first and second end tubes each including a threaded bore hole. The vehicle where the body includes a plurality of plates operatively connected to each other so as to allow telescopic adjustment of the deployable panel, the plates configured to house at least a portion of the linear actuator. The vehicle where: the first and second internal rods are mounted to a first plate via a first flange; the first and second intermediate plates are mounted to a second plate via a second flange; and the first and second end tubes are mounted directly to a third plate. The vehicle where each deployable panel is installed on a rear bumper of the vehicle. Implementations of the described techniques may include hardware, a method or process, or computer software on a computer-accessible medium.

One general aspect includes a method to deploy at least one deployable panel of a plurality of deployable panels, the method including: monitoring, via a processor, a vehicle speed; determining, via the processor, whether the vehicle speed is above or below a threshold value; and when the vehicle speed is above or equal to the threshold value, deploying at least one deployable panel of the plurality of deployable panels to an extended state. Other embodiments of this aspect include corresponding computer systems, apparatus, and computer programs recorded on one or more computer storage devices, each configured to perform the actions of the methods.

Implementations may include one or more of the following features. The method where, when the vehicle speed is below the threshold value, retain the at least one deployable panel of the plurality of deployable panels in a retracted state. The method where, when the vehicle speed is above the threshold value, the extended state is at a length proportional to the vehicle speed. The method further including: receiving, via the processor, sensor information from a sensor installed in the vehicle; and based on the sensor information, via the processor, determining whether to deploy one deployable panel of the plurality of deployable panels to an extended state or at least two deployable panels of the plurality of deployable panels to an extended state. The method where the sensor is a yaw rate sensor. The method where the sensor is an anemometer. The method further including: receiving, via the processor, vehicle location information and weather information; and based on the vehicle location information and weather information, via the processor, determining whether to deploy one deployable panel of the plurality of deployable panels to an extended state or at least two deployable panels of the plurality of deployable panels to an extended state. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

FIG. 1 is a perspective view of an exemplary aspect of a plurality of deployable panels being used in an exemplary environment;

FIG. 2 is another perspective view of another exemplary aspect of the deployable panels of FIG. 1 being used in the exemplary environment of FIG. 1;

FIG. 3A is another perspective view of another exemplary aspect of the deployable panels of FIG. 1 being used in the exemplary environment of FIG. 1;

FIG. 3B is another perspective view of another exemplary aspect of the deployable panels of FIG. 1 being used in the exemplary environment of FIG. 1;

FIG. 4 is a sideview of an exemplary aspect of a linear actuator assembly;

FIG. 5 is a sideview of another exemplary aspect of the linear actuator assembly of FIG. 4;

FIG. 6 is a cutaway perspective view of another exemplary aspect of the linear actuator assembly of FIG. 4;

FIG. 7 is a perspective view of another embodiment of the plurality of deployable panels being used in an exemplary environment;

FIG. 8 is a perspective view of another embodiment of the plurality of deployable panels being used in an exemplary environment;

FIG. 9 are perspective views of another exemplary aspect of an embodiment of the deployable panels being used in the exemplary environment; and

FIG. 10 is a flowchart of an exemplary process to deploy at least one deployable panel from a vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The deployable panels disclosed herein is an active airflow control device that can reduce the aerodynamic drag for a vehicle and improve the vehicle's stability while driving through environments having strong gusts of wind (i.e., external forces impacting at least one side of the vehicle). Moreover, these panels are designed to be activated at high vehicle speeds to improve fuel economy and reduce emissions and then these panels are retracted at lower speeds (or while in the park gear) to improve the vehicle's aesthetic. Vehicle electronics (such as the vehicle's telematics unit or electronics control unit) can control the length of the panels extension that is proportional to the vehicle's speed. The panels are also based on a multi-stage gear assembly to deploy the panels while also providing additional panel stability.

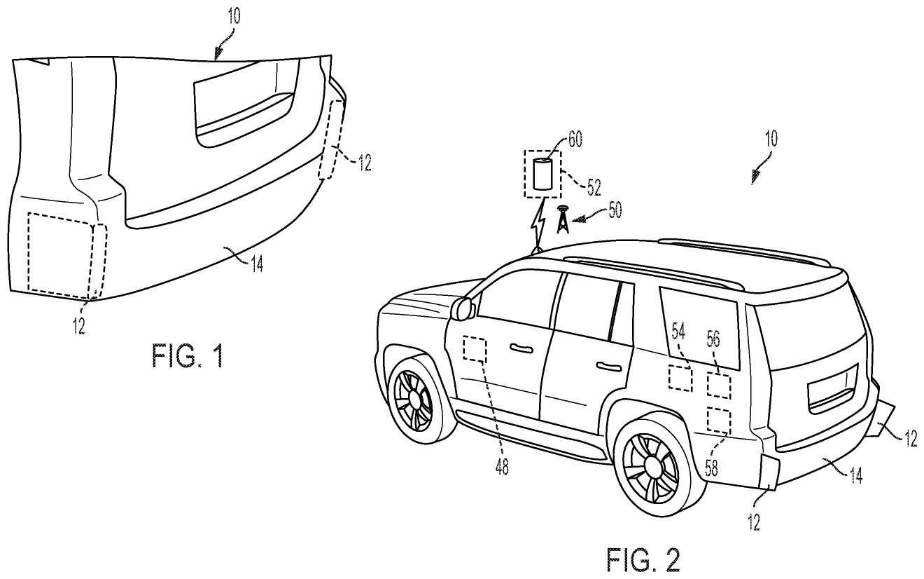

As shown in FIGS. 1 and 2, a vehicle 10 can include two deployable panels 12 installed at on the sides of the vehicle's rear end. While in a retracted state (FIG. 1), each of these deployable panels 12 will be hidden within the vehicle's bumper 14. As follows, each deployable panel 12 will be encapsulated within the confines of a respective pocket, which can be installed at one end of the bumper 14. Conversely, while in an extended state (FIG. 2), the deployable panels 12 are deployed from the pocket and telescopically stretched out in a lateral direction with respect to the periphery of the vehicle's bumper 14. The end of these panels 12 may also be protracted to a length of, for example, approximately eight inches from the rear edge of the bumper 14. Skilled artists should note that vehicle 10 is depicted in the illustrated embodiment as a sports utility vehicle (SUV), but it should be appreciated that any other vehicle including, but not limited to, trucks, busses, passenger sedans, recreational vehicles (RVs), construction vehicles (e.g., bulldozers), trains, trolleys, marine vessels (e.g., boats), aircraft, helicopters, amusement park vehicles, farm equipment, golf carts, trams, etc., can also be used.

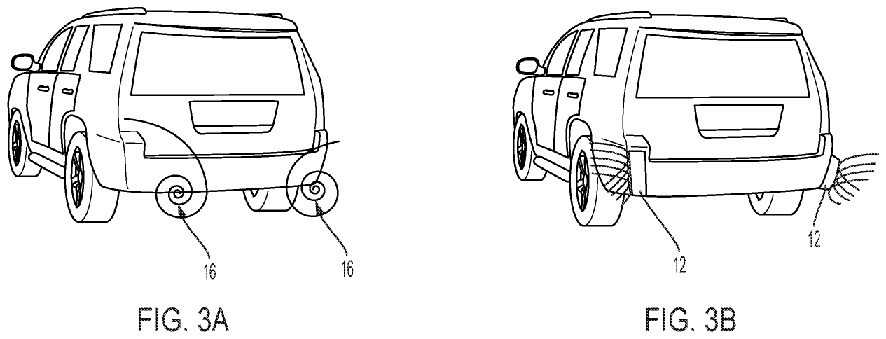

As can be seen in FIG. 3A, when vehicle 10 is moving with the deployable panels 12 being in a retracted state (or without deployable panels being installed in general), vortices of whirling air 16 are generated behind the rear end of the vehicle 10 (near the wheel wells). These vortices create aerodynamic drag on the moving vehicle 10. However, as can be seen in FIG. 3B, when the panels 12 are deployed, the airflow vortices are diminished, and air freely moves along the side of the vehicle's body and off its rear end and panel bodies. Thus, when the airflow around a vehicle can freely move off the moving vehicle's rear end, and away from the vehicle 10, the aerodynamic drag is minimalized, the vehicle's fuel economy is improved, and its greenhouse gas emissions are reduced.

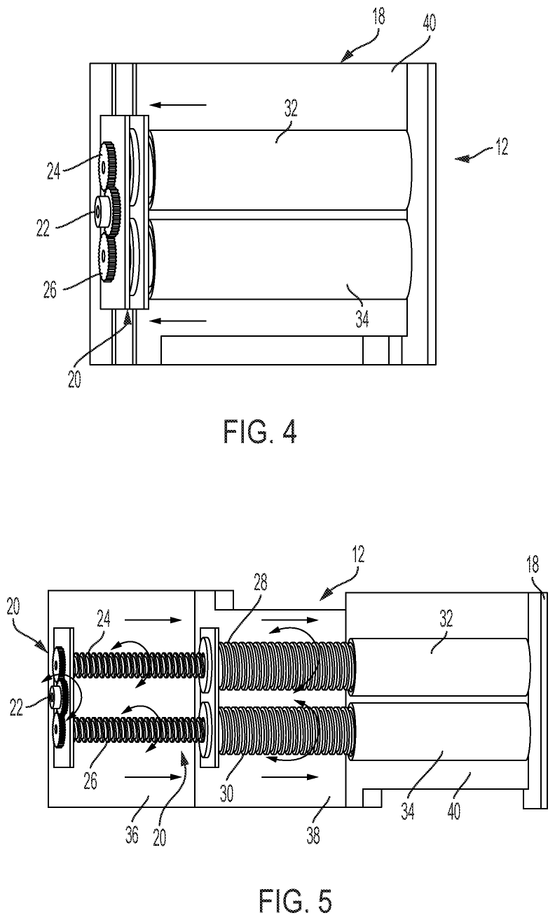

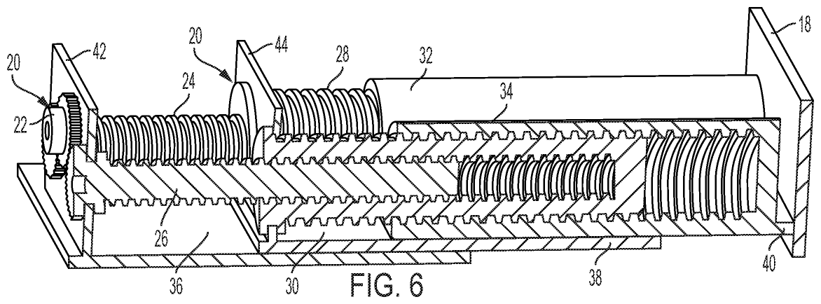

As can be seen in FIGS. 4-6, the deployable panel 12 includes a body 18 made up of a series of plates (discussed later) that house a linear actuator assembly 20. The linear actuator 20 is configured to telescopically adjust the body 18 of the deployable panel 12 from the retracted state (FIG. 4) to the fully extended state (FIG. 5—a length of approximately 8 inches, for example) and back to the retracted state (FIG. 4). Moreover, linear actuator 20 is designed to extend the deployable panel to some length in between the retracted state and the fully extended state (e.g., to a length of 2 inches, 4 inches, or 6 inches, for example).

The linear actuator 20 itself may include an actuator gear 22, which can be operatively connected to a rotating actuator within vehicle 10. In addition, the gear teeth of the actuator gear 22 are operatively connected to the gear teeth laterally positioned at one end of a first internal rod 24 and the teeth laterally positioned at one end of a second internal rod 26. As such, when the actuator gear 22 is rotated clockwise direction, the first internal rod 24 and the second internal rod 26 will be made to rotate counterclockwise direction. Likewise, when the actuator gear 22 is rotated in a counter clockwise direction, the first internal rod 24 and the second internal rod 26 will be made to rotate in a counterclockwise direction.

The opposite end of the first internal rod 24 (i.e., the one opposite the actuator gear 22) is operatively inserted into a bore hole of a first intermediate rod 28 and the similarly opposite end of the second internal rod 24 (i.e., the end opposite the actuator gear 22) is operatively inserted into a bore hole of a second intermediate rod 30. Both the first and second internal rods 24, 26 have a threaded exterior that corresponds to a threaded interior wall of the bore holes of the first and second intermediate rods 28, 30. Thus, when the first and second internal rods 24, 26 are made to rotate, the first and second intermediate rods 28, 30 will also be made to rotate in a respective manner. Moreover, the exterior threads on the first and second internal rods 24, 26 and the threads in the boreholes of the first and second intermediate rods 28, 30 are also designed to cause the first and second intermediate rods 28, 30 to telescopically extend away from or telescopically retract towards the first and second internal rods 24, 26 while the rods are rotating. Thus, for example, when the internal rods 24, 26 and the intermediate rods 28, 30 are rotating in a clockwise direction, the intermediate rods 28, 30 may telescopically extend away from the internal rods 24, 26. However, when the internal rods 24, 26 and the intermediate rods 28, 30 are rotating in a counter clockwise direction, the intermediate rods 28, 30 may telescopically retract towards the internal rods 24, 26.

The end of the first intermediate rod 28 opposite the first internal rod 24 is operatively inserted into a bore hole of a first end tube 32 and the end of the second intermediate rod 30 opposite the second internal rod 26 is operatively inserted into a bore hole of a second end tube 34. Both the first and second intermediate rods 28, 30 have a threaded exterior that corresponds to a threaded interior wall of the bore holes of the first and second end tubes 32, 34. Thus, when the first and second intermediate rods 24, 26 are made to rotate, the first and second end tubes 32, 34 will also be made to move in a telescopic manner. Moreover, the exterior threads on the first and second intermediate rods 28, 30 and the threads in the boreholes of the first and second end tubes 32, 34 are also designed to cause the first and second end tubes 32, 34 to telescopically extend away from or telescopically retract towards the first and second intermediate rods 28, 30 while the rods are rotating. Thus, for example, when the intermediate rods 28, 30 are rotating in a clockwise direction, the end tubes 32, 34 may telescopically extend away from the intermediate rods 28, 30. However, when the intermediate rods 28, 30 are rotating in a counter-clockwise direction, the end tubes 32, 34 may telescopically retract towards the intermediate rods 28, 30. As shown the first and second internal rods 24, 26, the first and second intermediate rods 28, 30 and the first and second end tubes 32, 34 have substantially circular cross sections. However, it should be understood that these components can have cross sections of different shapes.

As mentioned above, the body 18 includes a series of plates, a first plate 36, a second plate 38, and a third plate 40. When the deployable panel 12 is properly constructed, the plates are slidably connected together such that they will ensure the linear actuator 20 remains substantially enclosed within the body 18 while the panel 12 is extending and retracting. As can be seen, in one or more embodiments, the internal rods 24, 26 are mounted to the first plate 36 via a first flange 42. The intermediate rods 28, 30 are mounted to the second plate 38 via a second flange 44. However, the end tubes 32, 34 are molded directly onto the third plate 40, such that the tubes and plate make up a single-uniform component. It should be understood that the components of the linear actuator 20 can be made of a metallic material (e.g., steel) while the components of the body 18 can be made from a rigid material such as, but not limited to, resin, fiberglass, or plastic (or any other material that matches the rest of the rear bumper).

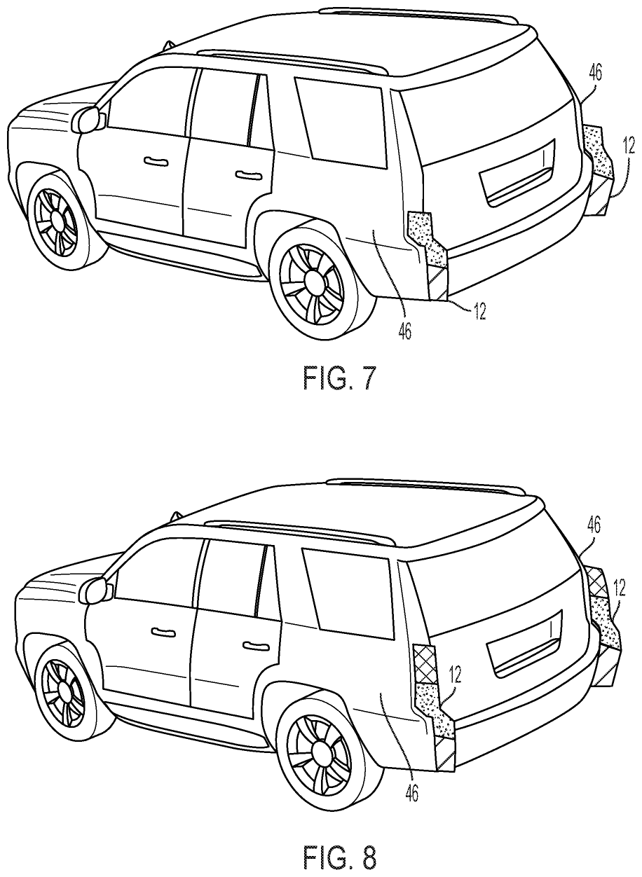

As shown in FIGS. 7 and 8, embodiments of the deployable panels 12 can be designed to extend vertically beyond the bumper 14 of vehicle 10 such that the panels deploy from the vehicle's rear quarter panels 46. Elongating the deployable panels 12 in a vertical manner can further facilitate the reduction of aerodynamic drag. For example, the embodiment of the panels 12 shown in FIG. 2, in which the panels only deploy from the rear bumper 14, can reduce the aerodynamic drag coefficient by seven (7) counts (ΔCd=−7 counts). Whereas, the embodiment of the panels 12 shown in FIG. 7, in which the panels span about halfway up the rear quarter panel 46, can reduce the aerodynamic drag coefficient by ten (10) counts (ΔCd=−10 counts). In addition, the embodiment of the panels 12 shown in FIG. 8, in which the panels span up to a point that is aligned with the rear windows, can reduce the aerodynamic drag coefficient by fourteen (14) counts (ΔCd=−14 counts).

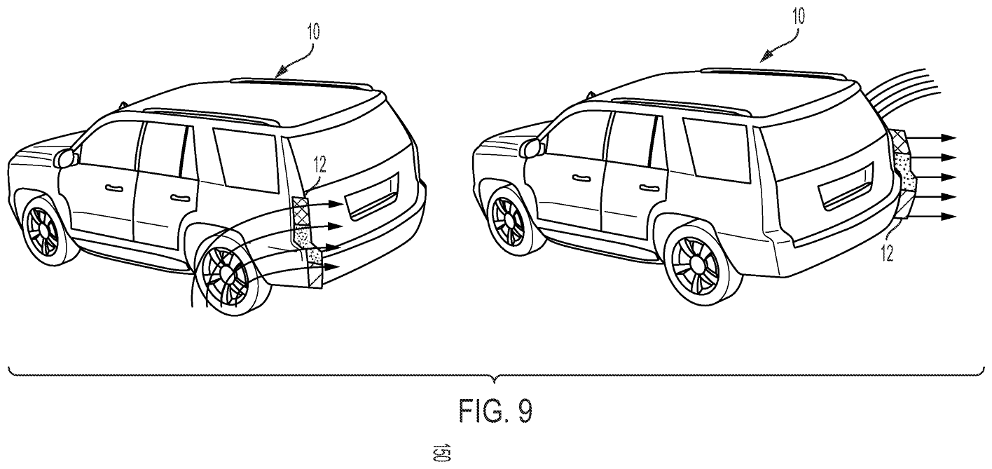

As shown in FIG. 9, while the vehicle 10 is traveling through an area experiencing severe wind gusts, one of the deployable panels 12 may be deployed to provide for added vehicle stability. As can be seen, the panel 12 on the side of the vehicle 10 being impacted by the side winds will be deployed to improve vehicle stability. As follows, when side winds are impacting the driver's side of the vehicle 10, the panel located on the driver's side of the rear bumper 14 can be deployed. Likewise, when side winds are impacting the passenger's side of the vehicle 10, the panel located on the passenger's side of the rear bumper 14 can be deployed.

### METHOD

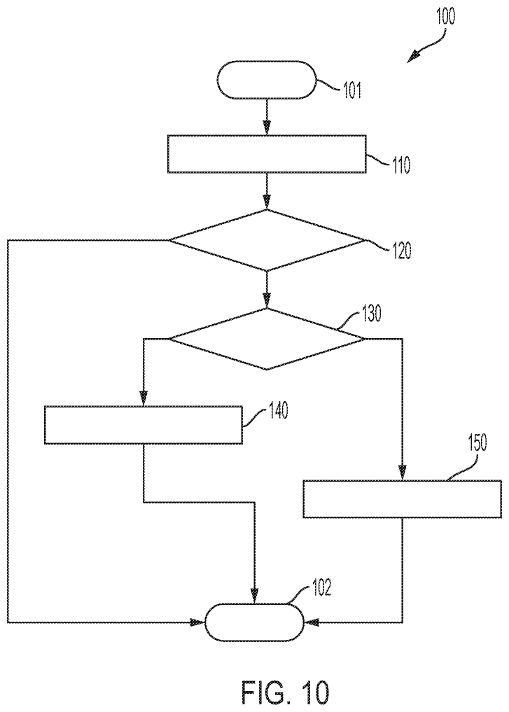

Turning now to FIG. 10, there is shown an embodiment of a method 100 to deploy at least one of the deployable panels 12 from vehicle 12. Method 100 moreover determines whether to deploy the panels 10 based on vehicle speed and then determines whether to deploy one panel 12 for vehicle stability control or both to deploy both panels 12 for aerodynamic drag reduction. One or more aspects of notification method 100 may be completed through an electronics control unit (ECU) 48 installed in vehicle 10 (see FIG. 1). The ECU 48 can be any known embedded system in automotive electronics that controls one or more of the electronic controls systems or subsystems in a vehicle, such as, for example, the vehicle's telematics unit. When the ECU 48 is embodied as a telematics unit (which are commonly known in vehicle systems) the ECU 48 will enable the vehicle 10 to communicate with remote entities 52, other telematics-enabled vehicles, or some other entity or device, via a wireless carrier system 50 (e.g., a cellular communications network). ECU 48 also includes a controller (processor) that can be any type of device capable of processing electronic instructions including microprocessors, microcontrollers, host processors, controllers, vehicle communication processors, and application specific integrated circuits (ASICs). The controller of the ECU 48 executes various types of digitally-stored instructions, such as software or firmware programs stored in an ECU embedded memory, which enable the ECU 48 (e.g., telematics unit) to provide a wide variety of services. For instance, the ECU 48 can execute programs or process data from the telematics memory to carry out the method discussed herein.

One or more ancillary aspects of method 100 may be completed by remote entity 52 or one or more vehicle devices such as, but not limited to, a yaw-rate sensor 54, a GPS module 56, and an anemometer 58 (see FIG. 1). Remote entity 52 can be one of a number of computers accessible via a private or public network such as the Internet. Remote entity 52 can be used for one or more purposes, such as a web server accessible by the vehicle via ECU 48 and wireless carrier system 50. Other such accessible remote entities 52 can be, for example: a service center computer (e.g., a SIP Presence server); a third-party client computer used by the ECU 48 to gain access to data and/or implement one or more software programs (a weather services application program interface); or a third-party repository to or from which vehicle data or other information is provided. The yaw-rate sensor 54 can be a piezoelectric or micromechanical device used to measures a vehicle's angular velocity around its vertical axis. The GPS module 56 can receive radio signals from a constellation of GPS satellites (not shown). From these signals, the GPS module 56 can determine vehicle position that is used for providing navigation and other position-related services to the vehicle driver. Anemometer 58 can be an ultrasonic device used for measuring wind speed and its corresponding direction.

Method 100 is supported by ECU 48 being configured to establish one or more communication protocols with one or more remote entities 52. This configuration may be established by a vehicle manufacturer at or around the time of the vehicle's assembly or after-market (e.g., via vehicle download using the wireless communication system 50 or at a time of vehicle service). In at least one implementation, one or more instructions are provided to the ECU 48 and stored on a non-transitory computer-readable medium (e.g., the memory of ECU 48).

Method 100 begins at 101 in which vehicle 10 is traveling along a path and moving at a certain speed. In step 110, the ECU 48 will monitor certain vehicle aspects. For example, ECU 48 will monitor the vehicle's speed through the vehicle's speedometer. In addition, ECU 48 may also monitor the vehicle's angular velocity via the yaw-rate sensor 54, the wind speed and corresponding direction via the anemometer 58. Moreover, ECU 48 may also monitor the surrounding weather conditions by retrieving the vehicle's location via the GPS module 56 and corresponding with a weather module 60 located at remote entity 52. The weather module 60 is a weather forecasting API that can be used to determine the weather at a certain location in real-time or at some future time (for example, see the DARK SKY or WEATHER BUG mobile applications).

In step 120, the ECU 48 will determine whether the vehicle speed is above or below a threshold vehicle speed value of, for example, thirty miles per hour (30 mph). Moreover, when the vehicle's speed is above or equal to 30 mph, method will move to step 130; otherwise, when the vehicle's speed is less than 30 mph, method 100 will move to completion 102 (in this instance, the panels will be retained in a retracted state because they were never deployed).

In step 130, ECU 48 will determine whether both panels 12 should be deployed to reduce drag or to deploy only one panel 12 due to severe winds impacting one side of the vehicle's body. In order to make this determination, for example, ECU 48 may review the data from anemometer 58 so as to determine whether the wind direction is only hitting one side of the vehicle and whether the wind speed is strong enough to destabilize the vehicle while moving along its path. In another example, ECU 48 may review the data from yaw-rate sensor 54 so as to determine whether the heading angle (ship angle) of the vehicle is being unduly shifted while moving along a straight-line path and which way the heading angle is being shifted (e.g., changes of greater than two (2) degrees/radians per second). In another example, ECU 48 may correspond with the GPS module 56 to get the vehicle's location and then correspond with the weather module 60 to get the current weather conditions in the vehicle's environment.

When the ECU 48 determines that both panels 12 should be deployed, method 100 will move to step 140. For example, this may be when the vehicle is moving above 30 mph but the ECU 48 sees that there are no strong wind forces impacting only one side of the vehicle 10 (i.e., when the yaw-rate sensor does not show major changes to the vehicle's heading angle, when the anemometer does not show strong winds in one direction or the strong winds are hitting the vehicle in a substantially even manner, or when the weather module 60 does not show severe wind gusts in the vehicle's environment). Alternatively, when ECU 48 determines that only one of panels 12 should be deployed, method 100 will move to step 150. For example, this may occur when the vehicle is moving more than 30 mph but the ECU 48 sees that there are strong wind forces impacting only one side of the vehicle 10 (i.e., when the yaw-rate sensor show a shift of more than two degrees/radians per second to the vehicle's heading angle, when the anemometer shows strong winds (greater than 20 mph) are hitting one of the vehicle's sides (driver/passenger side), or when the weather module 60 indicates that severe wind gusts (>20 mph) are currently occurring in the vehicle's environment).

In step 140, ECU 48 will deploy both of the deployable panels 12 to an extended state. Moreover, vehicle 10 may deploy these panels to a length that is proportional to the vehicle's travel speed. For example, if the vehicle is traveling at 35 mph, the ECU 48 may only deploy these panels 12 to an extended state that is four (4) inches beyond the edge of the vehicle's rear bumper 14. Alternatively, if the vehicle is traveling at 45 mph, the ECU 48 may only deploy these panels 12 to an extended state that is six (6) inches beyond the edge of the vehicle's rear bumper 14. However, if the vehicle is traveling above a predetermined maximum threshold speed (e.g., 55 mph) the ECU 48 may fully deploy these panels 12 to their maximum extension length (e.g., eight (8) inches beyond the edge of the vehicle's rear bumper 14). As discussed above, when the panels 12 are deployed, the aerodynamic drag generated at the rear end of the vehicle 12 will be substantially reduced. After step 140, method 100 will move to completion 102 (in this instance, both panels 12 will be retained in an extended state, at least for some duration of time).

In step 150, ECU 48 will only deploy one of the deployable panels 12. Moreover, ECU 48 will deploy the panel that corresponds to the side of the vehicle 10 being impacted by the side winds in the vehicle's environment. For example, if wind gusts are hitting the vehicle on the driver's side, the vehicle will deploy the deployable panel 12 at the rear end of the vehicle's driver side (as shown in FIG. 9). Likewise, if wind gusts are hitting the vehicle on the passenger side, the vehicle will deploy the deployable panel 12 at the rear end of the vehicle's passenger side (FIG. 9). Moreover, similar to step 140, the ECU 48 may also deploy this single panel to a length that is proportional to the vehicle's travel speed (discussed above). After step 150, method 100 will move to completion 102 (in this instance, only one panel 12 will be retained in an extended state, at least for some duration of time).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A deployable panel for a vehicle, the deployable panel comprising:
a telescopically adjustable body, wherein, when in a retracted state, the body is configured to be enclosed within at least a portion of the vehicle, and wherein, when in an extended state, the body is configured to reduce aerodynamic drag generated during movement of the vehicle or increase aerodynamic stability against external forces impacting at least one side of the vehicle; and
a linear actuator installed within the body, the linear actuator configured to telescopically adjust the body from the retracted state to the extended state or somewhere therebetween.

2. The deployable panel of claim 1, wherein the linear actuator comprises:
an actuation gear;
first and second internal rods being in operative contact with the actuation gear;
first and second intermediate rods being operatively connected to the first and second internal rods;
first and second end tubes being operatively connected to the first and second intermediate rods;
wherein, when the actuation gear is rotated in a first direction, the first and second internal rods will rotate respectively such that the first and second intermediate rods will both rotate respectively and telescopically extend away from the first and second internal rods and the first and second end tubes will telescopically extend away from the first and second intermediate rods; and
wherein, when the actuation gear is rotated in a second direction, the first and second internal rods will rotate respectively such that the first and second intermediate rods will both rotate respectively and telescopically retract towards the first and second internal rods and the first and second end tubes will telescopically retract towards the first and second intermediate rods.

3. The deployable panel of claim 2, wherein:
the first and second internal rods each having a threaded exterior;
the first and second intermediate rods each having a threaded exterior and a threaded bore hole; and
the first and second end tubes each comprising a threaded bore hole.

4. The deployable panel of claim 3, wherein the body comprises a plurality of plates operatively connected to each other so as to allow telescopic adjustment of the deployable panel, the plates configured to house at least a portion of the linear actuator.

5. The deployable panel of claim 4, wherein:
the first and second internal rods are mounted to a first plate via a first flange;
the first and second intermediate plates are mounted to a second plate via a second flange; and
the first and second end tubes are mounted directly to a third plate.

6. The deployable panel of claim 1 being installed at a side of a rear end of the vehicle.

7. The deployable panel of claim 1 being installed on a rear bumper of the vehicle.

8. A vehicle comprising:
a deployable panel located at each side of a rear end of the vehicle, each deployable panel comprising:
a telescopically adjustable body, wherein, when in a retracted state, the body is configured to be enclosed within at least a portion of the vehicle, and wherein, when in an extended state, the body is configured to reduce aerodynamic drag generated during movement of the vehicle; and
a linear actuator installed within the body, the linear actuator configured to telescopically adjust the body from the retracted state to the extended state or somewhere therebetween.

9. The vehicle of claim 8, wherein the linear actuator comprises:
an actuation gear;
first and second internal rods being in operative contact with the actuation gear;
first and second intermediate rods being operatively connected to the first and second internal rods;
first and second end tubes being operatively connected to the first and second intermediate rods;
wherein, when the actuation gear is rotated in a first direction, the first and second internal rods will rotate respectively such that the first and second intermediate rods will both rotate respectively and telescopically extend away from the first and second internal rods and the first and second end tubes will telescopically extend away from the first and second intermediate rods; and
wherein, when the actuation gear is rotated in a second direction, the first and second internal rods will rotate respectively such that the first and second intermediate rods will both rotate respectively and telescopically retract towards the first and second internal rods and the first and second end tubes will telescopically retract towards the first and second intermediate rods.

10. The vehicle of claim 9, wherein:
the first and second internal rods each having a threaded exterior;
the first and second intermediate rods each having a threaded exterior and a threaded bore hole; and
the first and second end tubes each comprising a threaded bore hole.

11. The vehicle of claim 10, wherein the body comprises a plurality of plates operatively connected to each other so as to allow telescopic adjustment of the deployable panel, the plates configured to house at least a portion of the linear actuator.

12. The vehicle of claim 11, wherein:
the first and second internal rods are mounted to a first plate via a first flange;
the first and second intermediate plates are mounted to a second plate via a second flange; and
the first and second end tubes are mounted directly to a third plate.

13. The vehicle of claim 8, wherein each deployable panel is installed on a rear bumper of the vehicle.

14. A method to deploy at least one deployable panel of a plurality of deployable panels, the method comprising:
monitoring, via a processor, a vehicle speed;
determining, via the processor, whether the vehicle speed is above or below a threshold value; and
when the vehicle speed is above or equal to the threshold value, deploying at least one deployable panel of the plurality of deployable panels to an extended state.

15. The method of claim 14, wherein, when the vehicle speed is below the threshold value, retain the at least one deployable panel of the plurality of deployable panels in a retracted state.

16. The method of claim 14, wherein, when the vehicle speed is above the threshold value, the extended state is at a length proportional to the vehicle speed.

17. The method of claim 14, further comprising:
receiving, via the processor, sensor information from a sensor installed in the vehicle; and
based on the sensor information, via the processor, determining whether to deploy one deployable panel of the plurality of deployable panels to an extended state or at least two deployable panels of the plurality of deployable panels to an extended state.

18. The method of claim 17, wherein the sensor is a yaw rate sensor.

19. The method of claim 17, wherein the sensor is an anemometer.

20. The method of claim 14, further comprising:
receiving, via the processor, vehicle location information and weather information; and
based on the vehicle location information and weather information, via the processor, determining whether to deploy one deployable panel of the plurality of deployable panels to an extended state or at least two deployable panels of the plurality of deployable panels to an extended state.
